(19) United States
(12) Patent Application Publication
(10) Pub. No.: US 2005/0175088 A1
(43) Pub. Date: Aug. 11, 2005

(54) Image coding using quantizer scale selection

(75) Inventors: Armand Victor Wemelsfelder, Krimpen a/d Ijssel (NL); Adrianus Cornelus Theodorus Maria Smolders, Hilversum (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/509,546

(22) PCT Filed: Mar. 27, 2003
(86) PCT No.: PCT/IB03/01246

(30) Foreign Application Priority Data
Mar. 28, 2002 (EP) 02076263.9

(51) Int. Cl. H04N 7/12

(52) U.S. Cl. 375/240.03; 375/240.24

(57) ABSTRACT

A video data stream is divided (11) into blocks. First quantization scales Q arc determined (17, 19) for respective ones of the blocks, so that the quantization scales Q are sufficiently large to realize a predetermined compression rate. Subsequently it is determined (17, 19) whether there is a second quantization scale Q′ that is larger than the first quantization scale Q for that at least one of the blocks and that results in a distortion of the at least one of the blocks that is less than or substantially equal to the distortion realized with the first quantization scale Q for the at least one of the blocks. The digital data stream is encoded (12, 13, 14) using the second quantization scale Q′ for the at least one of the blocks when said second quantization scale Q′ exists.

The invention relates to a method of coding video data and more in particular to the selection of a quantization scale to code the video data. The invention also relates to an apparatus that implements such a method.

U.S. Pat. No. 5,754,236 discloses a method of encoding video data according to the MPEG standard. Such encoding may be used in many different apparatuses, such as camcorders, video recording devices, video transmission devices for broadcast purposes or for telecommunication purposes.

The MPEG standard makes use of quantization to reduce the amount of data needed to encode the video data. MPEG, for example, uses quantization for encoding the DCT coefficients of the image content of macro blocks. Using quantization means that only a limited number of signal values Sm can be encoded (m=0, 1, 2 etc. indexes the different signal value values).
Sm=m*Q+So

Each other signal value S′ is replaced by one of the limited number of values Sm. This is called quantization. The distance Q between successive values that can be encoded is called the quantization scale Q.

The quantization scale Q is a prime parameter for controlling the amount of data that is needed to encode the video data, i.e. the compression rate. The larger the quantization scale Q, the less data is needed. On the other hand, the quantization scale Q affects the image distortion caused by encoding. The encoded image will deviate from the real image when the quantization scale does not have the minimum possible value. Generally, the distortion increases as the quantization scale Q increases.

Selection of the quantization scale Q is therefore based on a compromise between maximizing the compression rate and minimizing the distortion. In practice, the maximum amount of data that may be used to encode the video data is usually a hard parameter, determined by the available bandwidth, storage space etc. The quantization scale is adapted so that the amount of data does not exceed this maximum. A conventional algorithm sets the quantization scale Q to the minimum value that results in less than the maximum amount of data Usually a refinement of this conventional algorithm is used, in which the complexity of different macro-blocks of the image is computed first, an amount of data is allocated to the macro-block based on the complexity of the macro-block and the quantization scales of each different macro-block is set to respective minimum value that results in less than the allocated amount of data.

U.S. Pat. No. 5,754,236 describes an alternative that uses a search algorithm to search for an assignment of a set of quantization scales Q to different macro-blocks that minimizes the amount of data under the constraint that a predetermined compression rate is realized. That is, it does not set the quantization scales so that each macro-block individually realizes a predetermined compression rate. A non-exhaustive search algorithm is used to ensure a computationally feasible search.

The algorithm of U.S. Pat. No. 5,754,236 reaches the optimum quantization scale Q assignment in steps, each step increasing the quantization scale for a selected macro-block, for which a maximum increase of the compression rate can be achieved with a minimum increase in distortion. The steps are repeated, selecting different macro-blocks and increasing the quantization scale in the selected blocks until a predetermined compression rate is realized.

The objective of the present invention is to realize a further reduction of the amount of data needed to encode video data with little or no loss of distortion.

The invention provides for an encoding method according to claim 1. The invention is based on the insight that, although distortion generally increases with increasing quantization scale, this is not always the case. There may be local minima in the distortion as a function of quantization scale. This is the case for example when all signal values are the product of a same greatest common divisor. Accordingly, it has been realized that it is often possible to increase the compression rate without increasing distortion, or even with a decrease of distortion, by selecting a greater quantization scale than minimally needed to realize a given compression rate. Thus after using any algorithm to select quantization scales that ensure sufficient compression rate, additional compression can be realized by applying an optimization step that checks for the possibility of a further quantization scale reduction that substantially does not result in increased distortion.

The invention further relates to a method of finding an optimum quantizing scale by means of a feedback loop comparing the generated errors during quantization with different quantization scales, finding the better i.e. less error-generating quantization scale and proceeding to create an output bitstream utilizing the so found optimum quantization scale.

The invention further relates to a method in which the described optimization of the quantization scale is achieved by determining a common divisor of the quantized coefficients and multiplying the quantization scale with the computed value. The quantization scale is thus increased, resulting in a lower bitrate with the same or less quantization errors being made. Preferably the greatest common divisor of the coefficients is used.

By thus encoding a video sequence according to the encoding method of the invention, less bits are used without additional loss of picture quality by optimizing the quantization scale.

The invention further relates an audiovisual device, a data container device, a computer program and a data carrier device on which a computer program is stored.

Particularly advantageous elaborations of the invention are set forth in the dependent claims.

Further objects, elaborations, modifications, effects, and details of the invention appear from the following description, in which reference is made to the drawing, in which

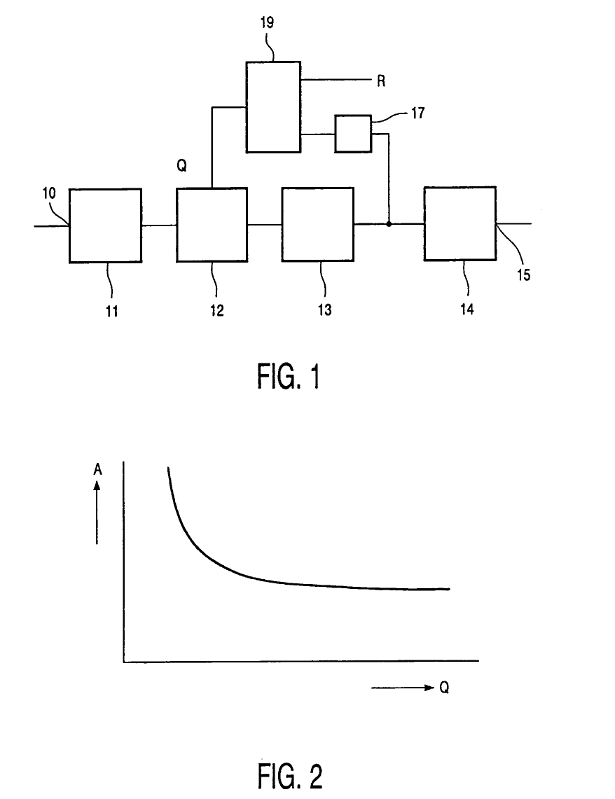

FIG. 1 shows an image compression apparatus;

FIG. 2 illustrates compression as a function of quantization scale;

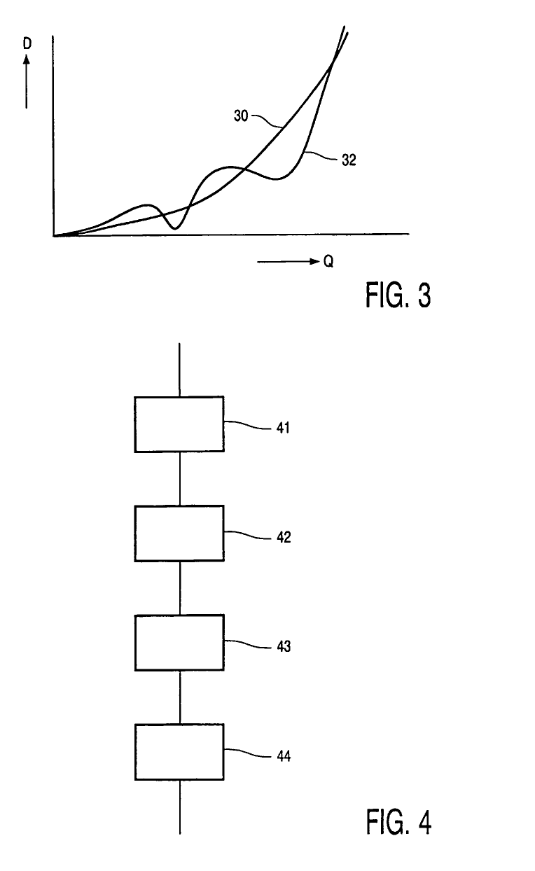

FIG. 3 shows distortion as a function of quantization scale;

FIG. 4 shows a flow diagram of an encoding method.

FIG. 1 schematically shows components of an image compression apparatus. The apparatus contains an input 10 for uncompressed video data and an output 15 for compressed video data. Between the input 10 and the output 15 the apparatus contains in succession a pre-processing unit 11, a quantizer 12, a variable length encoder 13 and a packaging unit 14. The apparatus also contains a length determining unit 17 and a quantization scale controller 19. The quantization scale controller 19 has an input for receiving a signal that indicates a required compression rate R and a quantization scale control output coupled to the quantizer 12 for specifying the quantization scale Q that should be used. The output of the variable length encoder 13 is coupled to an input of the length determining unit 17 and an output of the length determining unit 17 is coupled to an input of the quantization scale controller 19.

In operation uncompressed video data is supplied to input 10. Pre-processing unit 11 performs various preprocessing operations. In case of MPEG compression for example, preprocessing unit 11 divides the frames of video data into macro-blocks and computes DCT (Digital Cosine Transform) coefficients of the image data for each block. Quantizer 12 receives the coefficients and replaces them by quantized coefficients equal to a base value So plus an integer multiple of a quantization scale Q. Variable length encoder 13 encodes the quantized coefficients using a variable length code that has been selected to minimize the number of bits needed to encode the video data. Packaging unit 14 packages the encoded coefficients and outputs an MPEG signal, which may be used for transmission, recording etc. and ultimately for decoding and rendering with a television set (not shown) for example.

Quantization scale controller 19 controls the quantization scale used by quantizer 12. Quantization scale controller 19 ensures that the MPEG signal does not contain more bits than can be handled (for example within a given transmission bandwidth or memory space). Quantization scale controller 19 aims to realize a minimum of image distortion for a requested compression factor, or a maximum compression for a given distortion.

FIG. 2 shows the amount of data “A” needed to encode the image as a function of quantization scale Q. The amount A decreases as Q increases. The compression rate may be defined in terms of the amount A for example as R=U/A, where U is the amount of uncompressed data used to represent the image at input 10.

FIG. 3 shows distortion “D” as a function of quantization scale Q. Distortion may be defined in any known and/or convenient way, for example as a sum of absolute values of deviations of individual signal values, or as a sum of squares of such deviations. Two curves are shown. A first curve 30 illustrates the average expected distortion, averaged over all possible input images. A second curve 32 illustrates the distortion for an individual instance of a block in an image. As can be seen in the first curve 30 the distortion D strictly increases as a function of quantization scale Q. In the second curve 32 the distortion D generally follows the trend of the first curve 30, but it fluctuates. As a result the distortion D may locally decrease with increasing quantization scale Q.

Prior art compression techniques are primarily based on the first curve 30. They assume that, once a minimum quantization scale Q has been selected that reduces the amount of encoded data A to the required level with a minimum of distortion, any increase in quantization scale Q will increase the distortion D. However, this is true only on average. As shown by the second curve 32 of FIG. 3, for individual blocks it may be possible to reduce the amount of encoded data A without increasing distortion D or even with a reduction of distortion A. This is used in quantization scale controller.

FIG. 4 shows a flow diagram of quantization selection. In a first step 41, the apparatus receives and pre-processes a video frame. In a second step 42, a specification of a required compression rate R is received. In a third step 43, minimum values Q0 of the quantization scale Q are determined for different macro-blocks in the image, so that at least the required compression rate R is realized.

Any method may be used in third step 43. For example, one may measure the complexity of the image data in the different blocks and set an individual target amount of data An for each block (“n” being an index that indicates individual ones of the blocks) dependent on the complexity of each block, so that the aggregate of the target amounts An for all blocks does not exceed the required compression rate R. Subsequently, the quantization scale Qn for each block may be increased until it is measured that the resulting amount of data An′ does not exceed the target amount An. As another example, an algorithm may be used that reduces the quantization scales Qn of selected blocks sequentially until the total amount of data A has been reduced so that the required compression rate R is realized. As a result of the third step a minimum quantization scale values Q are selected that reduce the amount of data A below the level set by the required compression rate R.

In a fourth step 44 the apparatus checks whether an additional reduction of the amount of data A is possible without increasing the distortion D. That is, the apparatus checks whether the distortion D for individual blocks corresponds to a curve 32 with locally decreasing distortion D. If so, the apparatus replaces the quantization scale value Qn (that was selected for the block in the third step 43) by a higher quantization scale value Qn′ that does not increase the distortion.

In the fourth step 44 any method may be used to check whether there are such higher quantization scale values Qn′. In one embodiment, the distortion D′ is computed for all higher quantization scale values Qn′ and the highest quantization scale value Qn′ that leads to the smallest computed distortion D′ is selected if that distortion D′ is not substantially higher than the distortion D for the originally selected quantization scale value Qn.

In another embodiment, it is first determined whether a majority or all of the quantized signal values in a block share a greatest common divisor G bigger than one. If so, a quantization scale value Qn′=G*Qn may be used as new quantization scale value Qn′. This is based on the fact that no further distortion occurs if Qn is replaced by G*Qn when all signal values share a common divisor G. In a further embodiment, the distortion D′ is computed for that quantization scale value G*Qn and quantization scale values surrounding that value G*Qn, at increasing distance from G*Qn until D′ increases. In this case, the quantization scale value Qn′ for which a minimum distortion was thus found is preferably used.

Instead of the greatest common divisor G one may also determine and use a common divisor G′ of the quantized values (which necessarily is at least a divisor of the greatest common divisor), without checking whether it is the greatest common divisor. Under some practical circumstances it may take less computational effort to determine simply some common divisor without striving to determine the greatest common divisor.

In a fifth step 45 the quantization scale values Qn′ found in this way, together with unchanged quantization scale values Qn for blocks for which no new quantization scale value Qn′ was found, are output to quantizer 12 for computation of the final encoded image data.

Although the invention has been described mainly for MPEG encoding, it will be appreciated that it is not limited to MPEG encoding. For example, it may be applied to other forms of image encoding that encode blocks of image data using quantization, such as used for transmission of images over telecommunications networks.

The invention may be applied to transcoding as well, using encoded and compressed image data as input for the fourth step of the flow chart of FIG. 4. In this case, the original undistorted image data is not available. In the apparatus checks whether there are higher quantization scale values Qn′ that can replace the quantization scale values Qn of the encoded signal values S for a block so that substantially no change in quantized signal values S occurs in the block. One way of checking for such higher quantization scale values Qn′ is to test whether all or substantially all the quantized signal values S share a greatest common divisor G. If so a higher quantization scale value Qn+=G*Qn may be used without affecting distortion.

Although the invention may be implemented with dedicated hardware such as a quantization scale controller 19, it will be appreciated that the invention may also be implemented using a computer program for running on a computer system, at least including instructions for performing steps of a method according to the invention when run on a computer system or enabling a general propose computer system to perform functions of a computer system according to the invention. Such a computer program may be provided on a data carrier, such as a CD-rom or diskette, stored with data loadable in a memory of a computer system, the data representing the computer program. The data carrier may further be a data connection, such as a telephone cable or a wireless connection transmitting signals representing a computer program according to the invention.

1. A method of generating a compressed video data stream, wherein the data stream is divided into blocks of image data, the method comprising the steps of
determining first quantization scales Q for respective ones of the blocks, so that the quantization scales Q are sufficiently large to realize a predetermined compression rate;
determining, for at least one of the blocks, whether there is a second quantization scale Q′ that is larger than the first quantization scale Q for that at least one of the blocks and that results in a distortion of the at least one of the blocks that is less than or substantially equal to the distortion realized with the first quantization scale Q for the at least one of the blocks;
encoding the digital data stream using the second quantization scale Q′ for the at least one of the blocks when said second quantization scale Q′ exists.

2. A method according to claim 1, the method comprising
computing quantized coefficients for the at least one of the blocks;
calculating a common divisor of at least a majority of the quantized coefficients;
using a product of the greatest common divisor and the first quantization scale for the at least one of the blocks to determine the second quantization scale.

3. A method according to claim 1, the step of calculating a common divisor comprising the greatest common divisor of the at least a majority of the quantized coefficients.

4. A method according to claim 1, comprising
receiving an input video data stream wherein the blocks are encoded using the first quantization scales;
generating the encoded video data stream with requantized image data obtained from the input video data stream, using the second quantization scale Q.

5. An apparatus that generates a compressed video data stream, which is divided into blocks of image data, the apparatus comprising:
a quantizer for quantizing signal values with a quantization scale Q;
a quantization scale controller coupled to the quantizer for controlling the quantization scale Q dependent on a required compression rate, the quantization scale controller being arranged to determine the quantization scale in successive steps,
a first step determining first quantization scales Q for respective ones of the blocks, so that the quantization scales Q are sufficiently large to realize the compression rate,
a second step determining, for at least one of the blocks, whether there is a second quantization scale Q′ that is larger than the first quantization scale Q for that at least one of the blocks and that results in a distortion of the at least one of the blocks that is less than or substantially equal to the distortion realized with the first quantization scale Q for the at least one of the blocks.

6. An apparatus according to claim 5, the second step comprising
calculating a common divisor of at least a majority of quantized signal values computed using the first quantization scale Q for the block;
using a product of the greatest common divisor and the first quantization scale for the at least one of the blocks to determine the second quantization scale.

7. An apparatus according to claim 5, wherein the calculating of the common divisor comprises the greatest common divisor of the at least a majority of quantized signal values.

8. An apparatus according to claim 5, wherein the first step is performed by extracting the first quantization scales Q from a compressed input video data stream, an encoded video data stream being generated with requantized image data obtained from the input video data stream, using the second quantization scale Q.

9. A computer program product including instructions for performing steps of a method as claimed in claim 1.
